(19) United States
(12) Patent Application Publication
(10) Pub. No.: US 2025/0015964 A1
(43) Pub. Date: Jan. 9, 2025

(54) AGGREGATED PHYSICAL LAYER PROTOCOL DATA UNIT (A-PPDU) FORMAT FOR WIRELESS NETWORKS

(71) Applicant: NEWRACOM, Inc., Irvine, CA (US)

(72) Inventors: Heejung YU, Daejeon (KR); Joonsoo LEE, Seoul (KR); Si-Chan NOH, Seoul (KR); Il-Gu LEE, Seoul (KR)

(73) Assignee: NEWRACOM, Inc., Irvine, CA (US)

(21) Appl. No.: 18/753,864

(22) Filed: Jun. 25, 2024

Related U.S. Application Data
(60) Provisional application No. 63/511,775, filed on Jul. 3, 2023.

(51) Int. Cl. H04L 5/00; H04L 1/00

(52) U.S. Cl. CPC H04L 5/0094; H04L 1/0008; H04L 5/0055

(57) ABSTRACT

Disclosed herein is a method performed by a wireless device in a wireless network. The method includes wirelessly transmitting an aggregated physical layer protocol data unit (A-PPDU), wherein the A-PPDU includes a plurality of sub-PPDUs each occupying a different one of a plurality of subchannels, wherein all of the plurality of sub-PPDUs are addressed to a same station (STA). The A-PPDU may be used for realizing an efficient channel sounding process for a subchannel selective transmission (SST).

### CROSS-REFERENCE TO RELATED APPLICATION

This application claims the benefit of U.S. Provisional Application No. 63/511,775, filed Jul. 3, 2023, titled, “Aggregated PPDU format in multiple subchannels for beyond IEEE 802.11be networks,” which is hereby incorporated by reference.

### TECHNICAL FIELD

The present disclosure generally relates to wireless communications, and more specifically, relates to an aggregated physical layer protocol data unit (A-PPDU) format for use in a wireless network.

### BACKGROUND

Institute of Electrical and Electronics Engineers (IEEE) 802.11 is a set of physical and Media Access Control (MAC) specifications for implementing Wireless Local Area Network (WLAN) communications. These specifications provide the basis for wireless network products using the Wi-Fi brand managed and defined by the Wi-Fi Alliance. The specifications define the use of the 2.400-2.500 Gigahertz (GHz) as well as the 4.915-5.825 GHz bands. These spectrum bands are commonly referred to as the 2.4 GHz and 5 GHz bands. Each spectrum is subdivided into channels with a center frequency and bandwidth. The 2.4 GHz band is divided into 14 channels spaced 5 Megahertz (MHz) apart, though some countries regulate the availability of these channels. The 5 GHz band is more heavily regulated than the 2.4 GHz band and the spacing of channels varies across the spectrum with a minimum of a 5 MHz spacing dependent on the regulations of the respective country or territory.

WLAN devices are currently being deployed in diverse environments. These environments are characterized by the existence of many Access Points (APs) and non-AP stations (STAs) in geographically limited areas. Increased interference from neighboring devices gives rise to performance degradation. Additionally, WLAN devices are increasingly required to support a variety of applications such as video, cloud access, and offloading. Video traffic, in particular, is expected to be the dominant type of traffic in WLAN deployments. With the real-time requirements of some of these applications, WLAN users demand improved performance.

Subchannel selective transmission (SST) is a technique for transmitting data only in selected subchannels. SST may allow for dynamic spectrum utilization within a wide bandwidth. To implement SST, a channel sounding process is needed that allows the SST transmitter (e.g., an AP) to acquire channel quality information of each subchannel (e.g., average channel gain of each subchannel).

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example wireless local area network (WLAN) with a basic service set (BSS) that includes a plurality of wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates Inter-Frame Space (IFS) relationships, in accordance with some embodiments of the present disclosure.

FIG. 5 illustrates a Carrier Sense Multiple Access/Collision Avoidance (CSMA/CA) based frame transmission procedure, in accordance with some embodiments of the present disclosure.

FIG. 6 shows a table comparing various iterations of Institute of Electrical and Electronics Engineers (IEEE) 802.11 standard, in accordance with some embodiments of the present disclosure.

FIG. 7 shows a table, which describes fields of an Extreme High Throughput (EHT) frame format, in accordance with some embodiments of the present disclosure.

FIG. 8 is a diagram showing a format of an aggregated physical layer protocol data unit (A-PPDU) occupying an 80 MHz bandwidth, according to some embodiments.

FIG. 9 is a diagram showing a frame exchange sequence for performing channel sounding for a subchannel selective transmission (SST) using an A-PPDU and acknowledgement (ACK) feedback, according to some embodiments.

FIG. 10 is a diagram showing a frame exchange sequence for performing channel sounding for a SST using an A-PPDU and ACK and negative acknowledgement (NACK) feedback, according to some embodiments.

FIG. 11 is a flow diagram showing a method for performing a SST, according to some embodiments.

FIG. 12 is a diagram showing a frame exchange sequence for performing channel sounding for a SST using an A-PPDU and NACK feedback, according to some embodiments.

FIG. 13 is a diagram showing a frame exchange sequence for performing channel sounding for a SST using an A-PPDU and NACK feedback in a multi-STA scenario, according to some embodiments.

FIG. 14 is a flow diagram showing a method for transmitting an A-PPDU, according to some embodiments, according to some embodiments.

FIG. 15 is a flow diagram showing a method for receiving and processing an A-PPDU, according to some embodiments, according to some embodiments.

### DETAILED DESCRIPTION

One aspect of the present disclosure generally relates to wireless communications, and more specifically, relates to an aggregated physical layer protocol data unit (A-PPDU) format for use in a wireless network. The A-PPDU format may have multiple sub-PPDUs each occupying a different subchannel. All of the sub-PPDUs included in the A-PPDU may be addressed to the same station (STA). The A-PPDU format may allow the STA to separately decode each sub-PPDU within the A-PPDU (e.g., decode a particular sub-PPDU without having to decode the entire bandwidth).

An A-PPDU having the A-PPDU format may be used to realize an efficient channel sounding process for subchannel selective transmission (SST). According to some embodiments, the channel sounding process may involve a first STA (e.g., an AP) transmitting an A-PPDU to a second STA (e.g., a non-AP STA). The A-PPDU may include multiple sub-PPDUs each occupying a different subchannel. All of the sub-PPDUs may be addressed to the second STA. The second STA may attempt to separately decode each sub-PPDU included in the A-PPDU. The second STA may transmit one or more response frames to the first STA based on whether the second STA's attempts to decode the sub-PPDUs included in the A-PPDU were successful. For example, the second STA may transmit an acknowledgement (ACK) frame to the first STA in each subchannel in which the second STA was able to successfully decode a sub-PPDU of the A-PPDU. However, the receiver may transmit a negative acknowledgement (NACK) frame to the first STA (or not transmit a response frame) in each subchannel in which the second STA was not able to successfully decode a sub-PPDU of the A-PPDU. Receiving an ACK frame in a particular subchannel can be considered by the first STA as implicit feedback that the particular subchannel has good channel quality. Receiving a NACK frame (or not receiving a response) in a particular subchannel can be considered by the first STA as implicit feedback that the particular subchannel has poor channel quality. The first STA may select one or more subchannels for use in the SST based on the response frames and transmit a data frame in the selected subchannels as part of the SST. For example, the first STA may select the subchannels in which an ACK frame was received from the second STA for use in the SST and/or exclude the subchannels in which a NACK frame was received from the second STA from being used in the SST. The first STA may then transmit a data frame to the second STA in the selected subchannels as part of the SST.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

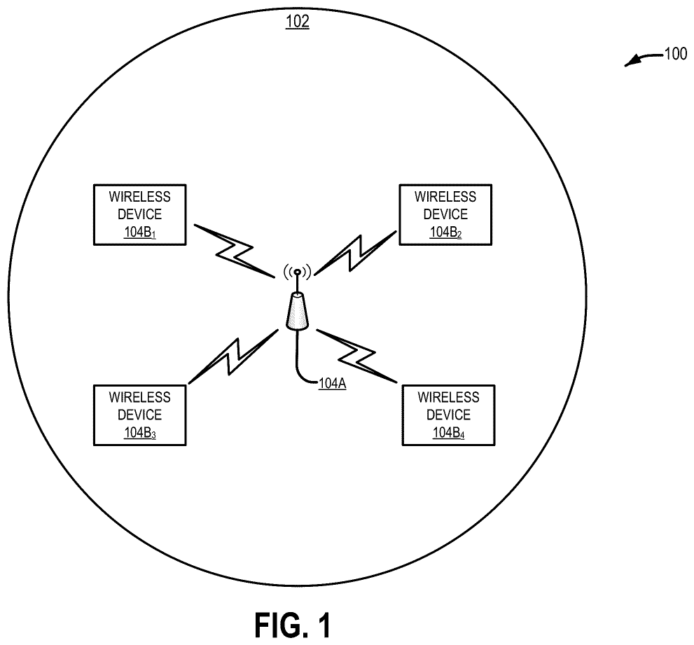

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs. Although shown with four non-AP STAs (e.g., the wireless devices 104B₁-104B₄), the WLAN 100 may include any number of non-AP STAs (e.g., one or more wireless devices 104B).

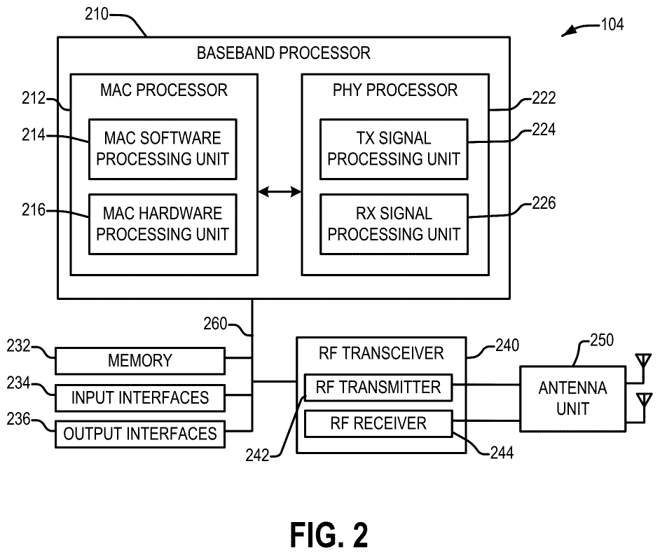

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in cither hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

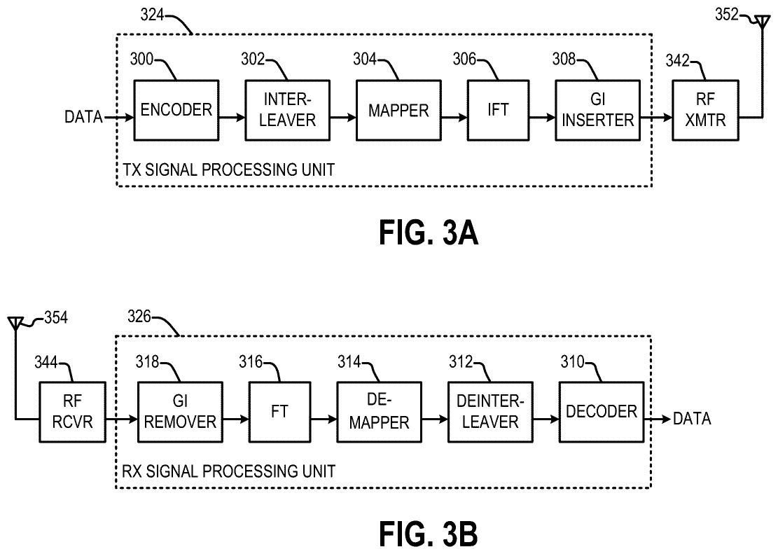

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of Os or Is. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

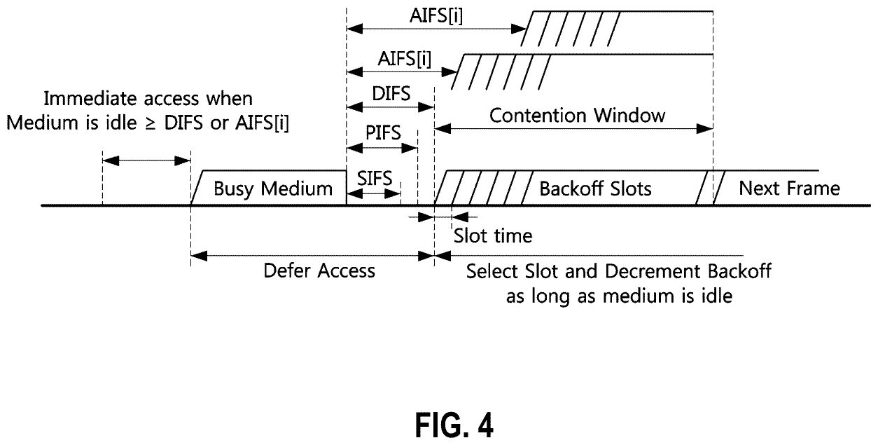

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS [i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS [AC]) has elapsed. When transmitted by the QoS STA, any of the data frame, the management frame, and the control frame, which is not the response frame, may use the AIFS [AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

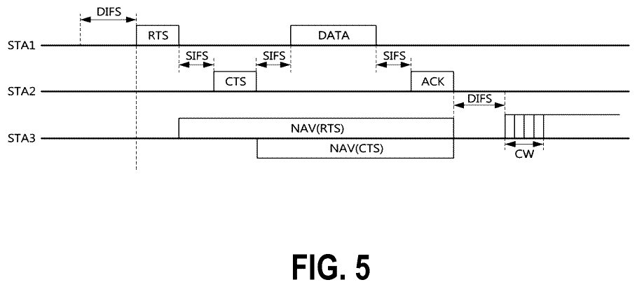

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 docs not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

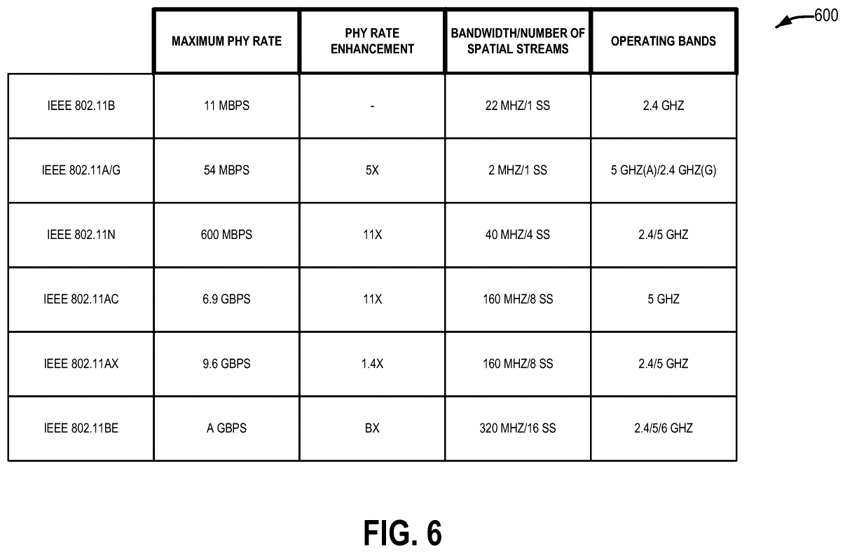

With clear demand for higher peak throughput/capacity in a WLAN, a new working group has been assembled to generate an amendment to IEEE 802.11. This amendment is called IEEE 802.11be (i.e., Extreme High Throughput (EHT)) and was created to support an increase to the peak PHY rate of a corresponding WLAN. Considering IEEE 802.11b through 802.11ac, the peak PHY rate has been increased by 5× to 11× as shown in FIG. 6, which presents a table 600 comparing various iterations of IEEE 802.11. In case of IEEE 802.11ax, the 802.11ax working group focused on improving efficiency, not peak PHY rate in dense environments. The maximum PHY rate (A Gbps) and PHY rate enhancement (Bx) for IEEE 802.11be could rely on the highest MCS (e.g., 4,096 QAM and its code rate).

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHZ) for IEEE 802.11be, more than 1 GHz of additional unlicensed spectrum is likely to be available because the 6 GHz band (5.925-7.125 GHZ) is being considered for unlicensed use. This would allow APs and STAs to become tri-band devices. Larger than 160 MHz data transmissions (e.g., 320 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

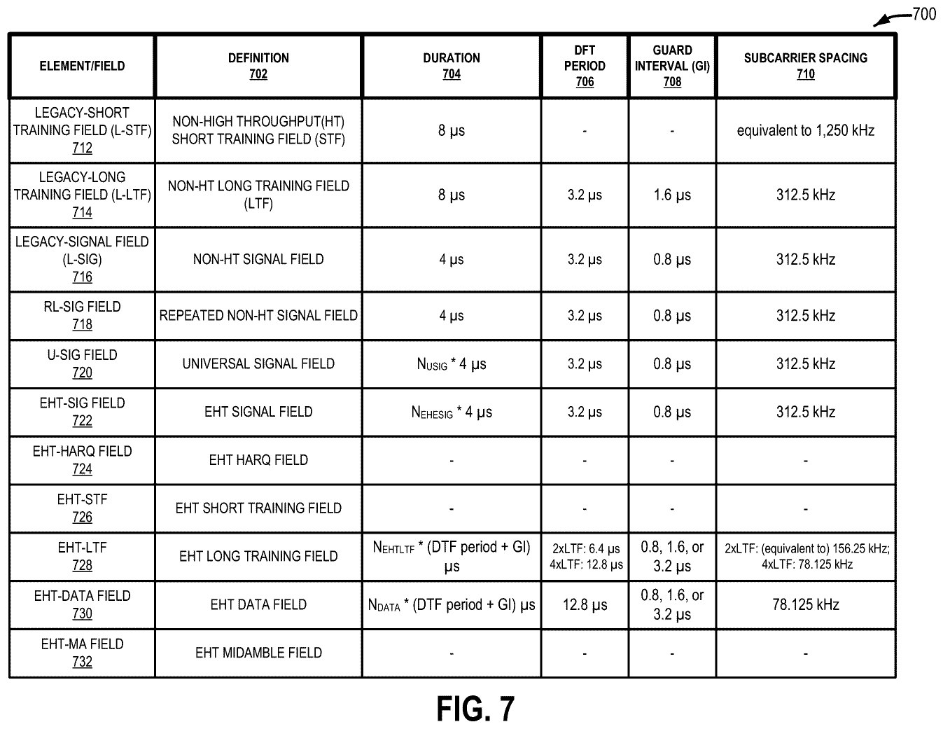

In some embodiments, a transmitting STA generates a PPDU frame and transmits it to a receiving STA. The receiving STA receives, detects, and processes the PPDU. The PPDU can be an EHT PPDU that includes a legacy part (e.g., a legacy short training field (L-STF), a legacy long training field (L-LTF), and a legacy signal (L-SIG) field), an EHT signal A field (EHT-SIG-A), an EHT signal B field (EHT-SIG-B), an EHT hybrid automatic repeat request field (EHT-HARQ), an EHT short training field (EHT-STF), an EHT long training field (EHT-LTF), and an EHT-DATA field. FIG. 7 includes a table 700, which describes fields of an EHT frame format. In particular, table 700 describes various fields that may be within the PHY preamble, data field, and midamble of an EHT frame format. For example, table 700 includes definitions 702, durations 704, Discrete Fourier transform (DFTs) periods 706, guard intervals (GIs) 708, and subcarrier spacings 710 for one or more of a legacy short training field (L-STF) 712, legacy long training field (L-LTF) 714, legacy signal field (L-SIG) 716, repeated L-SIG (RL-SIG) 718, universal signal field (U-SIG) 720, EHT signal field (EHT-SIG) 722, EHT hybrid automatic repeat request field (EHT-HARQ) 724, EHT short training field (EHT-STF) 726, EHT long training field (EHT-LTF) 728, EHT data field 730, and EHT midamble field (EHT-MA) 732.

The distributed nature of a channel access network, such as in IEEE 802.11 wireless networks, makes carrier sensing mechanisms important for collision free operation. The physical carrier sensing mechanism of one STA is responsible for detecting the transmissions of other STAs. However, it may be impossible to detect every single case in some circumstances. For example, one STA which may be a long distance away from another STA may see the medium as idle and begin transmitting a frame while the other STA is also transmitting. To overcome this hidden node, a network allocation vector (NAV) may be used. However, as wireless networks evolve to include simultaneous transmission/reception to/from multiple users within a single basic service set (BSS), such as uplink (UL)/downlink (DL) multi-user (MU) transmissions in a cascading manner, a mechanism may be needed to allow for such a situation. As used herein, a multi-user (MU) transmission refers to cases that multiple frames are transmitted to or from multiple STAs simultaneously using different resources. Examples of different resources are different frequency resources in OFDMA transmissions and different spatial streams in MU-MIMO transmissions. Therefore, DL-OFDMA, DL-MU-MIMO, UL-OFDMA, and UL-MU-MIMO are examples of MU transmissions.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

To improve WLAN systems, AP cooperation has been discussed as a possible technology to be adopted in IEEE 802.11be, where there is high level classification depending on various AP cooperation schemes. For example, there is a first type of cooperation scheme in which data for a user is sent from a single AP (sometimes referred to as “coordinated”) and there is a second type of cooperation scheme in which data for a user is sent from multiple APs (sometimes referred to as “joint”).

For the coordinated scheme, multiple APs are 1) transmitting on the same frequency resource based on coordination and forming spatial nulls to allow for simultaneous transmission from multiple APs or 2) transmitting on orthogonal frequency resources by coordinating and splitting the spectrum to use the spectrum more efficiently. For the joint scheme, multiple APs are transmitting jointly to a given user.

The frequency selectivity of a channel frequency response can be exploited for efficient spectrum utilization in wide bandwidth transmissions. For example, data can be transmitted more reliably by transmitting the data in subchannels with higher channel gain. SST is a technique for transmitting data only in selected subchannels. For SST, the SST transmitter (e.g., an AP) should obtain information regarding the channel quality of each subchannel through a channel sounding process. A channel sounding process using a null data packet announcement (NDPA) frame and a null data packet (NDP) frame for beamformed transmissions was introduced in previous IEEE 802.11 wireless networking standards (e.g., in IEEE 802.11n/ac/ax/be). Such NDP-based channel sounding process incurs unnecessary overhead for SST because SST does not require obtaining the magnitude and phase of each subcarrier, but just requires obtaining the channel quality of each subchannel (e.g., the average channel gain of the subcarriers in each subchannel). Another conventional channel sounding process involves the transmitter sequentially transmits data frames or control frames to the receiver in each subchannel to allow the receiver to measure the channel quality of each subchannel. The receiver may then transmit channel quality information of each subchannel to the transmitter. However, such sequential channel sounding process may take a relatively long time to obtain the channel quality information of all subchannels. When using a wideband PPDU (e.g., a PPDU occupying the entire bandwidth), it is difficult to assess the channel quality of each subchannel with ACK frame feedback. The ACK frame feedback just indicates that the overall channel quality is good enough for the receiver to correctly decode a data frame. However, the channel qualities of individual subchannels cannot be accurately assessed with such ACK frame feedback. An A-PPDU format is described herein that can be used to realize a more efficient channel sounding process.

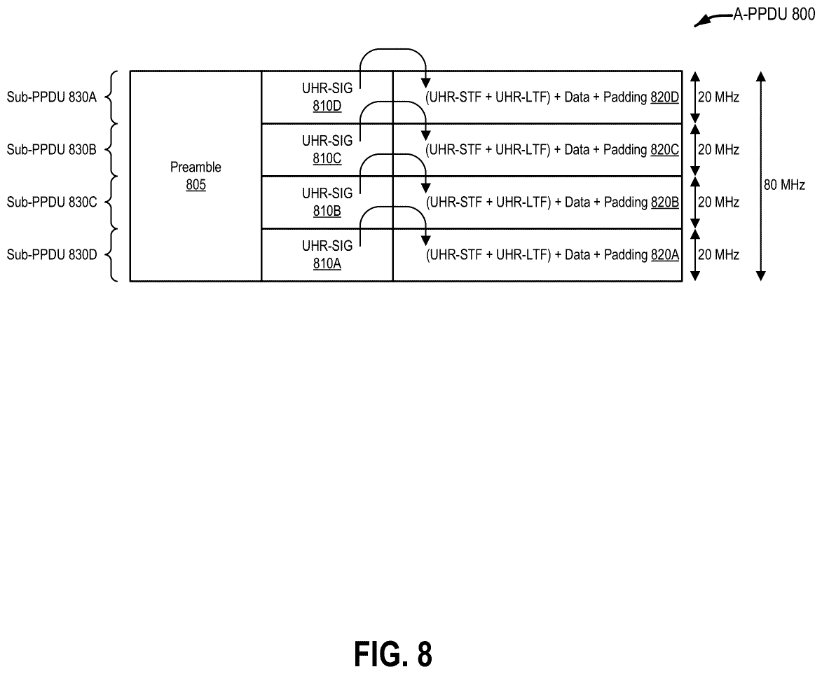

FIG. 8 is a diagram showing a format of an A-PPDU occupying an 80 MHZ bandwidth, according to some embodiments.

As shown in the diagram, the A-PPDU 800 may occupy an 80 MHz bandwidth.

The 80 MHz bandwidth may be divided into four 20 MHz subchannels. The A-PPDU 800 may include a preamble 805, UHR-SIG fields 810A-D, and data and padding fields 820A-D. The preamble 805 may be common across the entire 80 MHz bandwidth. The preamble 805 may be a legacy preamble or similar preamble (e.g., such that it is compatible with legacy IEEE 802.11 wireless networking standards such as IEEE 802.11ax and IEEE 802.11bc) and may include fields such as a legacy signal (L-SIG) field. In an embodiment, each 20 MHz subchannel has a separate preamble. As shown in the diagram, UHR-SIG 810A and data and padding field 820A may occupy the first 20 MHz subchannel, UHR-SIG 810B and data and padding field 820B may occupy the second 20 MHz subchannel, UHR-SIG 810C and data and padding field 820C may occupy the third 20 MHz subchannel, and UHR-SIG 810D and data and padding field 820D may occupy the fourth 20 MHz subchannel. Each data and padding field 820 may include data and padding. Each UHR-SIG field 810 may include information regarding the data and padding included in the corresponding data and padding field 820 occupying the same subchannel. In an embodiment, one or more of the data and padding fields 820 include the same data and padding to allow the receiver to more reliably recover/decode the data and padding (and thus reduce the amount of retransmissions). In an embodiment, all of the data padding fields 820 include different data and padding. The contents of the A-PPDU occupying each 20 MHz subchannel may be considered to be a separate sub-PPDU 830. Thus, the A-PPDU 800 shown in the diagram may be considered as including sub-PPDU 830A, sub-PPDU 830B, sub-PPDU 830C, and sub-PPDU 830D, with each sub-PPDU occupying a different 20 MHz subchannel. In an embodiment, each sub-PPDU 830 further includes a UHR short training field and a UHR long training field (UHR-STF+UHR-LTF) between the UHR-SIG field 810 and the data and padding field 820. It should be appreciated that a sub-PPDU 830 can include other fields than what is shown in the diagram.

In an embodiment, all of the sub-PPDUs 830 included in the A-PPDU 800 may be addressed to the same STA. In an embodiment, at least two of the sub-PPDUs 830 included in the A-PPDU 800 may be addressed to the same STA. Transmitting the A-PPDU 800 with multiple sub-PPDUs 830 addressed to the same STA may be less efficient in terms of data rate compared to transmitting a single wideband PPDU to the STA (e.g., due to the unused subcarriers in the boundaries between subchannels), but as will be described herein in additional detail, such A-PPDU 800 may be used to realize an efficient channel sounding process for SST. In an embodiment, different sub-PPDUs 830 included in the A-PPDU 800 may be addressed to different STAs. In an embodiment, as shown in the diagram, all of the sub-PPDUs included in the A-PPDU 800 have the same PPDU format (e.g., all sub-PPDUs have an ultra high reliability (UHR) PPDU format). In an embodiment, at least two of the sub-PPDUs 830 included in the A-PPDU 800 have different PPDU formats (e.g., one sub-PPDU 830 may have a UHR PPDU format, another sub-PPDU 830 included in the same A-PPDU 800 may have a high efficiency (HE) PPDU format, and yet another sub-PPDU 830 included in the same A-PPDU 800 may have an extremely high throughput (EHT) PPDU format). In an embodiment, each sub-PPDU 830 included in the A-PPDU 800 has a bandwidth that is a multiple of 20 MHZ (e.g., 20 MHz, 40 MHz, 80 MHz, or 160 MHZ).

A STA that receives the A-PPDU 800 or an A-PPDU having a similar format may be able to separately decode each sub-PPDU 830 included in the A-PPDU 800. That is, a STA may be able to separately decode different sub-PPDUs 830 of the A-PPDU 800 occupying different 20 MHz subchannels. This is because each 20 MHz sub-PPDU 830 has its own UHR-SIG field 810 that allows the receiving STA to obtain information needed to decode the data/payload included in the sub-PPDU 830 such as information regarding the modulation coding scheme (MCS), the bandwidth, the resource unit (RU) allocation, etc. While the A-PPDU 800 is shown in the diagram as occupying an 80 MHz bandwidth and the sub-PPDUs 830 included in the A-PPDU 800 are shown in the diagram as occupying a 20 MHz subchannel bandwidth, it should be appreciated that the A-PPDU 800 can occupy a different bandwidth size (e.g., 160 MHz or 320 MHZ) and/or the sub-PPDUs 830 can occupy a different subchannel bandwidth size (e.g., 40 MHz, 80 MHz, 160 MHZ). Also, it should be appreciated that different sub-PPDUs 830 within the same A-PPDU 800 can occupy different subchannel bandwidth sizes. Thus, the A-PPDU format shown in the diagram should be regarded as illustrative rather than limiting. As will be described in additional detail herein, the A-PPDU 800 or an A-PPDU having a similar format may be used for realizing an efficient channel sounding process.

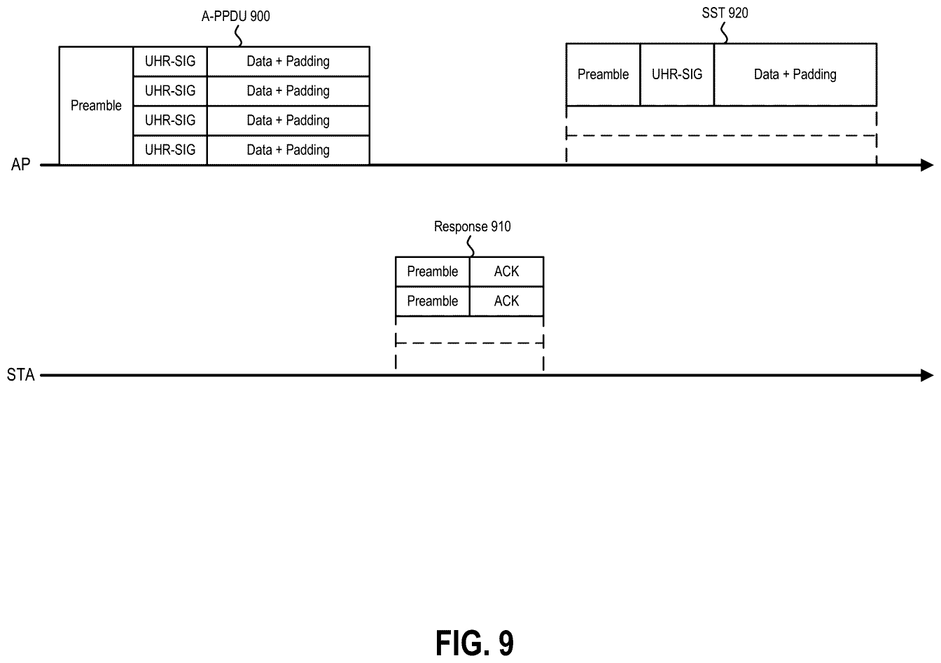

FIG. 9 is a diagram showing a frame exchange sequence for performing channel sounding for a SST using an A-PPDU and ACK feedback, according to some embodiments.

As shown in the diagram, an AP may transmit an A-PPDU 900 to a STA. The A-PPDU 900 may have the A-PPDU format shown in FIG. 8 or a similar format. The A-PPDU 900 may occupy an 80 MHz channel/bandwidth. The A-PPDU 900 may include four sub-PPDUs each occupying a different 20 MHz subchannel within the 80 MHZ channel/bandwidth.

The STA may attempt to separately decode each sub-PPDU included in the A-PPDU 900. The STA may then transmit an ACK frame to the AP in each subchannel in which the sub-PPDU of the A-PPDU was successfully decoded (without error) in its response 910 to the A-PPDU 900. In the example shown in the diagram, it is assumed that the STA was able to successfully decode the sub-PPDUs of the A-PPDU 900 occupying the third and fourth 20 MHZ subchannels (the upper two 20 MHz subchannels shown in the diagram), but was not able to successfully decode the sub-PPDUs occupying the first and second 20 MHz subchannels (the lower two 20 MHz subchannels shown in the diagram). Thus, the STA may transmit separate ACK frames to the AP in the third and fourth 20 MHz subchannels in its response 910 to the A-PPDU 900.

In an embodiment, the STA transmits the ACK frames to the AP as part of an A-PPDU. Such A-PPDU may referred to as a response A-PPDU because it is transmitted in response to the A-PPDU 800 transmitted by the AP. In an embodiment, the response A-PPDU and the original A-PPDU 800 use the same subchannel partitioning (e.g., 80 MHz bandwidth divided into four 20 MHz subchannels).

The AP may use the ACK frames or the lack thereof as implicit feedback of the channel quality of the subchannels. In the example shown in the diagram, the AP receives ACK frames from the STA in the third and fourth 20 MHz subchannels. Thus, the AP may consider the third and fourth 20 MHz subchannels as having good channel quality. Also, in this example, the AP does not receive an ACK frame from the STA in the first and second 20 MHZ subchannels. Thus, the AP may consider the first and second 20 MHz subchannels as having poor channel quality.

The AP may select one or more 20 MHz subchannels for use in a SST 920 based on the ACK frames it received from the STA. For example, the AP may select the 20 MHZ subchannels in which it received an ACK frame from the STA for use in the SST 920. In this example, since the AP received ACK frames from the STA in the third and fourth 20 MHZ subchannels (which indicates that those 20 MHz subchannels have good channel quality), the AP may select those subchannels for use in the SST 920. However, the AP may exclude the first and second 20 MHz subchannels from being used in the SST 920 because the AP did not receive an ACK frame from the STA in those 20 MHz subchannels (which indicates that those 20 MHz subchannels have poor channel quality). The AP may then transmit a data frame to the STA in the selected 20 MHz subchannels as part of the SST 920. In the example shown in the diagram, the AP transmits a data frame in the third and fourth 20 MHz subchannels (the upper 40 MHz subchannel) as part of the SST 920. In an embodiment, the AP may transmit a separate data frame in each selected subchannel (e.g., transmit one data frame in the third 20 MHz subchannel and transmit a different data frame in the fourth 20 MHz subchannel) as part of the SST 920 instead of transmitting a single data frame that occupies the selected subchannels.

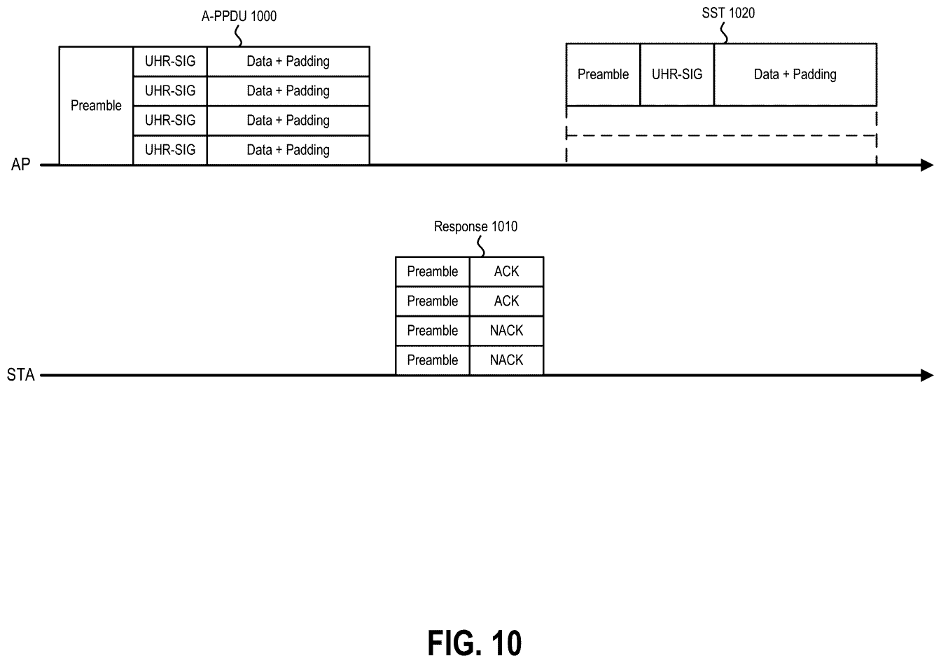

FIG. 10 is a diagram showing a frame exchange sequence for performing channel sounding for a SST using an A-PPDU and ACK and NACK feedback, according to some embodiments.

In an embodiment, in addition to transmitting an ACK frame in each 20 MHZ subchannel in which the STA was able to successfully decode a sub-PPDU of an A-PPDU, the STA may transmit a negative acknowledgement (NACK) frame in each 20 MHz subchannel in which the STA was not able to successfully decode a sub-PPDU of the A-PPDU (e.g., not able to successfully decode the data and padding included in the sub-PPDU). For example, after the AP transmits an A-PPDU 1000 to the STA, the STA may attempt to separately decode each sub-PPDU included in the A-PPDU. In the example shown in the diagram, it is assumed that the STA was able to successfully decode the sub-PPDUs of the A-PPDU 1000 included in the third and fourth 20 MHz subchannels, but that the STA was not able to successfully decode the sub-PPDUs included in the first and second 20 MHz subchannels. Thus, the STA may transmit separate ACK frames to the AP in the third and fourth 20 MHz subchannels and transmit separate NACK frames to the AP in the first and second 20 MHz subchannels in its response 1010 to the A-PPDU 1000. Transmitting the NACK frame(s) may allow the AP to more accurately assess the channel quality of subchannels by allowing the AP to obtain some feedback regarding subchannels having poor channel quality (instead of only obtaining feedback regarding subchannels having good channel quality). The AP may then select one or more subchannels for use in an SST 1020 and transmit data frame(s) in the selected subchannels as part of the SST 1020, as described above. For example, in the example shown in the diagram, the AP transmits a data frame in the third and fourth 20 MHz subchannels (the upper 40 MHZ subchannel) as part of the SST 1020 because ACK frames were received in those 20 MHZ subchannels. The first and second 20 MHz subchannels are unoccupied in the SST 1020 because the AP received NACK frames in those 20 MHz subchannels.

In an embodiment, the STA transmits the ACK frames and NACK frames to the AP as part of a response A-PPDU. In an embodiment, the response A-PPDU and the original A-PPDU 900 use the same subchannel partitioning.

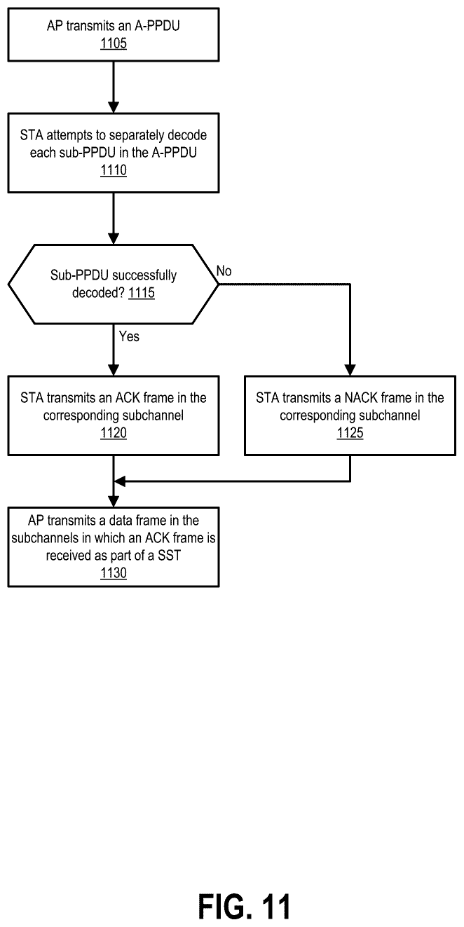

FIG. 11 is a flow diagram showing a method for performing a SST, according to some embodiments.

As shown in the diagram, at operation 1105, the AP transmits an A-PPDU to a STA. The A-PPDU may include multiple sub-PPDUs each occupying a different subchannel. In an embodiment, the A-PPDU has the format shown in FIG. 8 or a similar format.

At operation 1110, the STA attempts to separately decode each sub-PPDU included in the A-PPDU.

The STA may perform operations 1115-1125 for each sub-PPDU included in the A-PPDU.

At operation 1115, the STA determines whether the sub-PPDU was successfully decoded (e.g., decoded without error). If the sub-PPDU was successfully decoded, the flow proceeds to operation 1120. At operation 1120, the STA transmits an ACK frame to the AP in the corresponding subchannel (the same subchannel that the sub-PPDU occupied). Returning to operation 1115, if the sub-PPDU was not successfully decoded, the flow proceeds to operation 1125. At operation 1125, the STA transmits a NACK frame to the AP in the corresponding subchannel (the same subchannel that the sub-PPDU occupied).

At operation 1130, the AP transmits a data frame in the subchannels in which an ACK frame was received (but not in the subchannels in which a NACK frame was received) as part of the SST.

In an embodiment, the ACK frames and/or NACK frames include channel quality information (CQI) for the subchannels (e.g., information regarding the average channel gain of each subchannel). The CQI for the subchannels may be included in a media access control (MAC) field (e.g., a field in the MAC header) or UHR-SIG field (in the preamble) of an ACK frame or NACK frame.

Upon receiving the ACK frames and/or NACK frames, the AP may extract the CQI for the subchannels from those frames and assign/determine a channel quality value to/for each subchannel based on the CQI. The AP may then compare each channel quality value with a predefined threshold channel quality value. The predefined threshold channel quality value may be determined/set based on the SNR (signal-to-noise ratio) needed for successful SST. The AP may select subchannels having a channel quality value that meets the predefined threshold value for use in the SST (and exclude subchannels having a channel quality value that does not meet the predefined threshold value from being used in the SST).

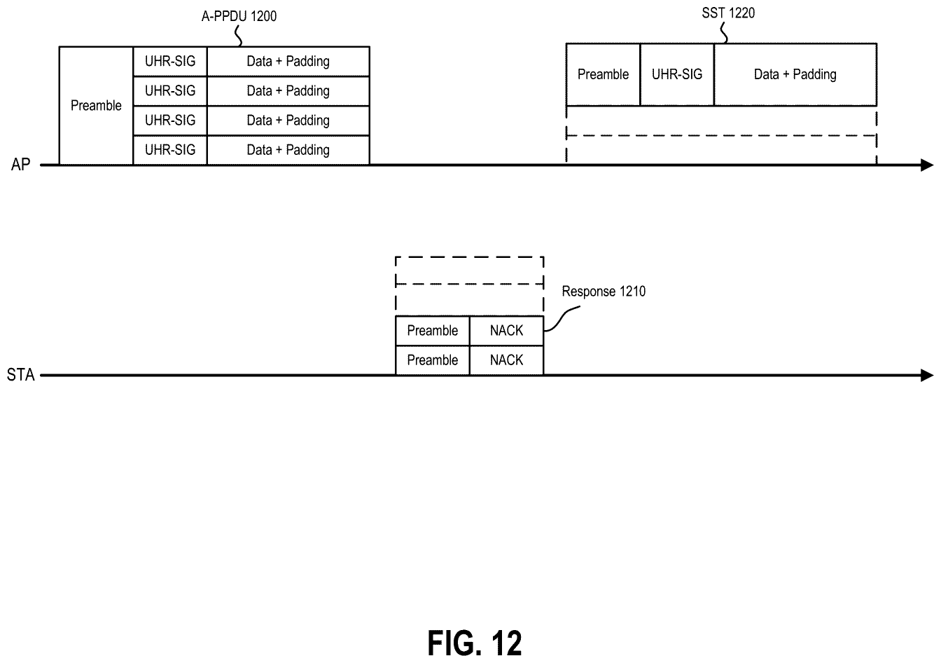

FIG. 12 is a diagram showing a frame exchange sequence for performing channel sounding for a SST using an A-PPDU and NACK feedback, according to some embodiments.

In an embodiment, the STA does not transmit ACK frames in its response to the A-PPDU but only transmits NACK frames. For example, in the example shown in the diagram, after the AP transmits an A-PPDU 1200 to the STA, the STA may attempt to separately decode each sub-PPDU included in the A-PPDU 1200. In the example shown in the diagram, it is assumed that the STA was able to successfully decode the sub-PPDUs included in the third and fourth 20 MHz subchannels, but that the STA was not able to successfully decode the sub-PPDUs included in the first and second 20 MHz subchannels. Thus, the STA may transmit separate NACK frames to the AP in the first and second 20 MHz subchannels in its response 1210 to the A-PPDU 1200, but not transmit response frames in the first and second 20 MHz channels. The AP may decide to exclude any subchannels in which a NACK frame is received from being used in the SST 1220. In this example, the AP thus selects the third and fourth 20 MHz subchannels for use in the SST 1220, but excludes the first and second 20 MHZ channels from being used in the SST 1220. The AP may then transmit a data frame in the selected subchannels as part of SST 1220. Thus, in the example shown in the diagram, the AP transmits a data frame in the third and fourth 20 MHz subchannels (the upper 40 MHZ subchannel) as part of the SST 1220.

In an embodiment, the STA transmits the NACK frames to the AP as part of a response A-PPDU. In an embodiment, the response A-PPDU and the original A-PPDU 1000 use the same subchannel partitioning.

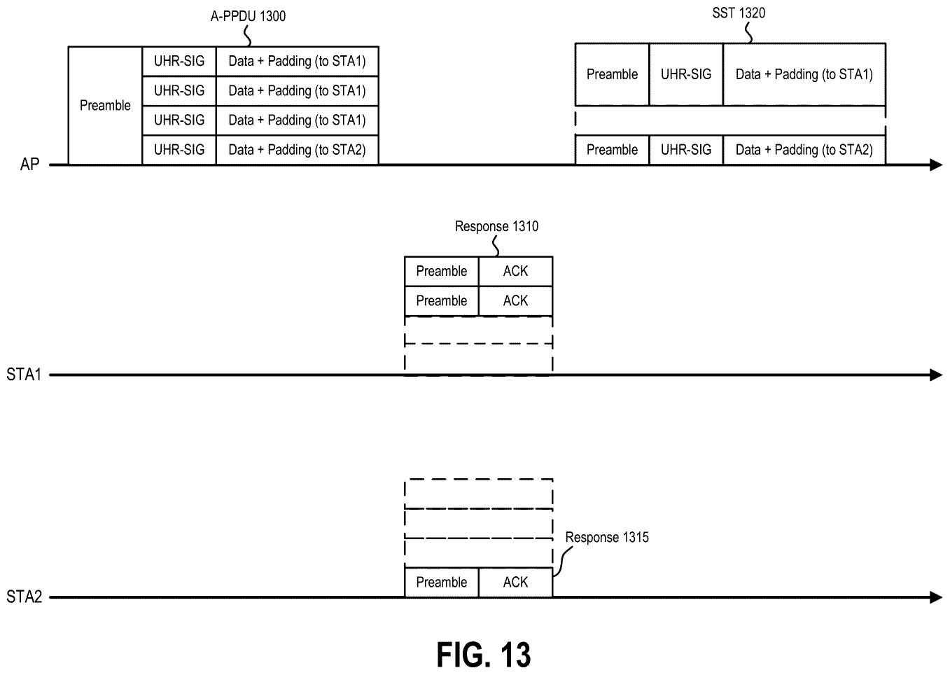

FIG. 13 is a diagram showing a frame exchange sequence for performing channel sounding for a SST using an A-PPDU and NACK feedback in a multi-STA scenario, according to some embodiments.

The A-PPDU format may also be used for channel sounding in a multi-STA scenario. As shown in the diagram, the AP may transmit an A-PPDU 1300. The A-PPDU 1300 may occupy an 80 MHz bandwidth. The A-PPDU 1300 may include multiple sub-PPDUs that are addressed to multiple different STAs. Each sub-PPDU may occupy a different 20 MHZ subchannel of the 80 MHz bandwidth. For example, in the example shown in the diagram, the A-PPDU 1300 includes one sub-PPDU that is addressed to STA2 (occupying the first 20 MHZ subchannel) and three sub-PPDUs that are addressed to STA1 (occupying the second, third, and fourth 20 MHz subchannels, respectively).

As a response to the A-PPDU 1300, STA1 and STA2 may transmit a separate ACK frame to the AP in each subchannel in which it was able to successfully decode a sub-PPDU of the A-PPDU 1300. In this example, it is assumed that STA1 was able to successfully decode the sub-PPDUs of the A-PPDU 1300 occupying the third and fourth 20 MHz subchannels but was not able to successfully decode the sub-PPDU occupying the second 20 MHz subchannel. Thus, STA1 may transmit an ACK frame in the third and fourth 20 MHz subchannels in its response 1310 to the A-PPDU (but not transmit an ACK frame in the second 20 MHZ subchannel). Also, in this example, it is assumed that STA2 was able to successfully decode the sub-PPDU of the A-PPDU 1300 occupying the first 20 MHz subchannel. Thus, STA2 may transmit an ACK frame to the AP in the first 20 MHz subchannel in its response 1315 to the A-PPDU 1300.

The AP may then select one or more subchannels for use in a SST 1320 based on the responses and transmit data frames in the selected subchannels as part of the SST 1320. In the example shown in the diagram, the AP transmits a data frame to STA2 in the first 20 MHZ subchannel and transmits a data frame to STA1 in the third and fourth 20 MHz subchannels (the upper 40 MHz subchannel) as part of the SST 1320. The second 20 MHz subchannel is unoccupied because the AP did not receive an ACK frame from STA1 in that 20 MHZ subchannel.

In an embodiment, the STAs simultaneously transmit the ACK frames to the AP as part of a response A-PPDU (e.g., by forming a multi-user uplink OFDMA transmission). In an embodiment, the response A-PPDU and the original A-PPDU 1000 use the same subchannel partitioning.

For the sake of illustration, embodiments are primarily described in a context of a wireless network that operates in an 80 MHz bandwidth that is divided into four 20 MHZ subchannels. It should be appreciated that the techniques described herein can be used with other bandwidth sizes (e.g., wider bandwidths such as 160 MHz bandwidth or 320 MHZ bandwidth) and can be used with other subchannel sizes (e.g., 40 MHZ, 80 MHZ, 160 MHZ, etc.).

The A-PPDU format disclosed herein may provide certain benefits. The A-PPDU format disclosed herein allows the receiver to separately decode individual sub-PPDUs included in the A-PPDU. The A-PPDU can be used to realize an efficient channel sounding process for purposes of SST. SST may allow for more efficient utilization of a wide bandwidth.

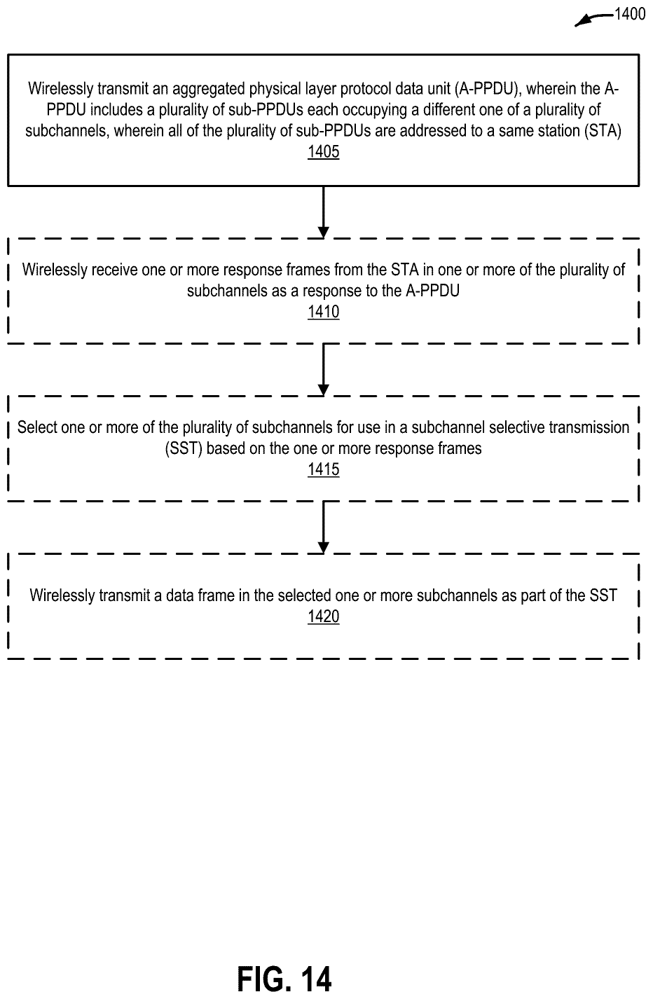

Turning now to FIG. 14, a method 1400 will be described for transmitting an A-PPDU, in accordance with an example embodiment. The method 1400 may be performed by a wireless device such as wireless device 104.

Additionally, although shown in a particular order, in some embodiments the operations of the method 1400 (and the other methods shown in the other figures) may be performed in a different order. For example, although the operations of the method 1400 are shown in a sequential order, some of the operations may be performed in partially or entirely overlapping time periods.

In an embodiment, at operation 1405, the wireless device wirelessly transmits an A-PPDU, wherein the A-PPDU includes a plurality of sub-PPDUs each occupying a different one of a plurality of subchannels, wherein all of the plurality of sub-PPDUs are addressed to a same STA. In an embodiment, each of the plurality of subchannels has a bandwidth that is a multiple of 20 MHz. In an embodiment, each sub-PPDU of the plurality of sub-PPDUs includes a signal field that includes information regarding data and padding included in the sub-PPDU. In an embodiment, each sub-PPDU of the plurality of sub-PPDUs further includes an UHR short training field and a UHR long training field between the signal field included in the sub-PPDU and the data and padding included in the sub-PPDU. In an embodiment, all of the plurality of sub-PPDUs have a same PPDU format. In an embodiment, the same PPDU format is a UHR PPDU format. In an embodiment, at least two of the plurality of sub-PPDUs have different PPDU formats. In an embodiment, one or more of the plurality of sub-PPDUs include a same data and padding. In an embodiment, all of the plurality of sub-PPDUs include different data and padding.

In an embodiment, at operation 1410, the wireless device wirelessly receives one or more response frames from the STA in one or more of the plurality of subchannels as a response to the A-PPDU. In an embodiment, the one or more response frames are received as part of a response A-PPDU transmitted by the STA. In an embodiment, the A-PPDU and the response A-PPDU use a same subchannel partitioning.

In an embodiment, at operation 1415, the wireless device selects one or more of the plurality of subchannels for use in a SST based on the one or more response frames. In an embodiment, the one or more response frames include one or more ACK frames, and the selected one or more subchannels are subchannels in which the one or more ACK frames were received. Additionally or alternatively, in an embodiment, the one or more response frames include one or more NACK frames, and the selected one or more subchannels exclude subchannels in which the one or more NACK frames were received.

In an embodiment, at operation 1420, the wireless device wirelessly transmits a data frame in the selected one or more subchannels as part of the SST.

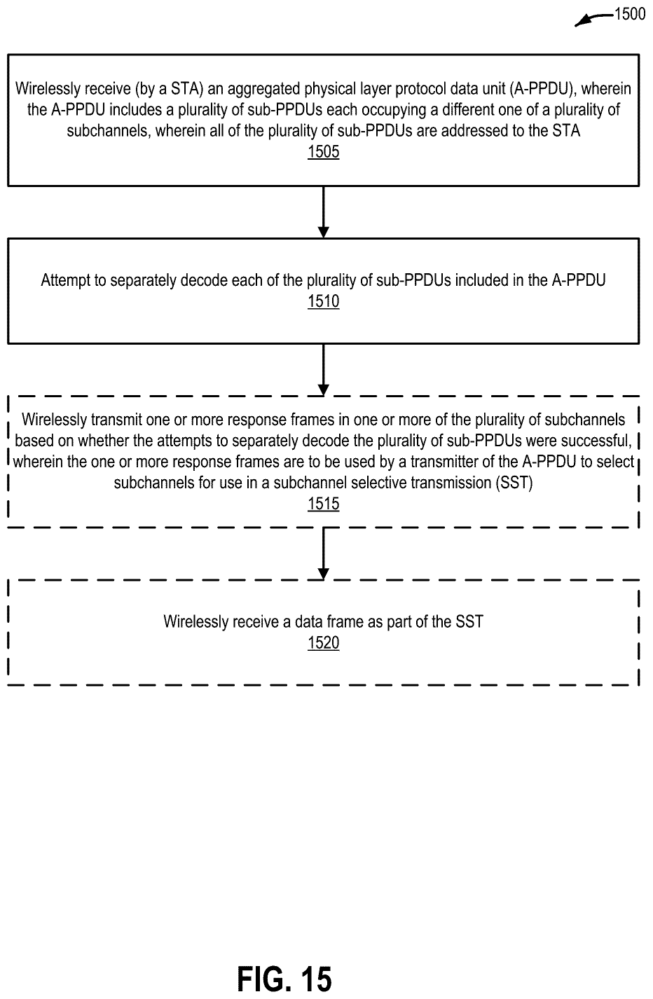

Turning now to FIG. 15, a method 1500 will be described for receiving and processing an A-PPDU, in accordance with an example embodiment. The method 1500 may be performed by a wireless device such as wireless device 104.

At operation 1505, the wireless device, which is functioning as a STA in a wireless network, wirelessly receives an A-PPDU, wherein the A-PPDU includes a plurality of sub-PPDUs each occupying a different one of a plurality of subchannels, wherein all of the plurality of sub-PPDUs are addressed to the STA. In an embodiment, each of the plurality of subchannels has a bandwidth that is a multiple of 20 MHz. In an embodiment, each sub-PPDU of the plurality of sub-PPDUs includes a signal field that includes information regarding data and padding included in the sub-PPDU. In an embodiment, each sub-PPDU of the plurality of sub-PPDUs further includes an UHR short training field and a UHR long training field between the signal field included in the sub-PPDU and the data and padding included in the sub-PPDU. In an embodiment, all of the plurality of sub-PPDUs have a same PPDU format. In an embodiment, the same PPDU format is a UHR PPDU format. In an embodiment, at least two of the plurality of sub-PPDUs have different PPDU formats. In an embodiment, one or more of the plurality of sub-PPDUs include a same data and padding. In an embodiment, all of the plurality of sub-PPDUs include different data and padding.

At operation 1510, the wireless device attempts to separately decode each of the plurality of sub-PPDUs included in the A-PPDU.

In an embodiment, at operation 1515, the wireless device wirelessly transmits one or more response frames in one or more of the plurality of subchannels based on whether the attempts to separately decode the plurality of sub-PPDUs were successful, wherein the one or more response frames are to be used by a transmitter of the A-PPDU to select subchannels for use in a SST. In an embodiment, the one or more response frames include one or more ACK frames that occupy one or more subchannels of the plurality of subchannels in which the attempt to decode a sub-PPDU of the A-PPDU was successful. Additionally or alternatively, in an embodiment, the one or more response frames include one or more NACK frames that occupy one or more of the plurality of subchannels in which the attempt to decode a sub-PPDU of the A-PPDU was unsuccessful. In an embodiment, the one or more response frames are transmitted in a response A-PPDU. In an embodiment, the A-PPDU and the response A-PPDU use a same subchannel partitioning.

In an embodiment, at operation 1520, the wireless device wirelessly receives a data frame as part of the SST (receives the data frame in the subchannels selected by the transmitter).

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a wireless device, comprising:
wirelessly transmitting an aggregated physical layer protocol data unit (A-PPDU), wherein the A-PPDU includes a plurality of sub-PPDUs each occupying a different one of a plurality of subchannels, wherein all of the plurality of sub-PPDUs are addressed to a same station (STA).

2. The method of claim 1, wherein each of the plurality of subchannels has a bandwidth that is a multiple of 20 Megahertz (MHz).

3. The method of claim 1, wherein each sub-PPDU of the plurality of sub-PPDUs includes a signal field that includes information regarding data and padding included in the sub-PPDU.

4. The method of claim 3, wherein each sub-PPDU of the plurality of sub-PPDUs further includes an ultra high reliability (UHR) short training field and a UHR long training field between the signal field included in the sub-PPDU and the data and padding included in the sub-PPDU.

5. The method of claim 1, wherein all of the plurality of sub-PPDUs have a same PPDU format.

6. The method of claim 5, wherein the same PPDU format is an ultra high reliability (UHR) PPDU format.

7. The method of claim 1, wherein at least two of the plurality of sub-PPDUs have different PPDU formats.

8. The method of claim 1, wherein one or more of the plurality of sub-PPDUs include a same data and padding.

9. The method of claim 1, wherein all of the plurality of sub-PPDUs include different data and padding.

10. The method of claim 1, further comprising:
wirelessly receiving one or more response frames from the STA in one or more of the plurality of subchannels as a response to the A-PPDU;
selecting one or more of the plurality of subchannels for use in a subchannel selective transmission based on the one or more response frames; and
wirelessly transmitting a data frame in the selected one or more subchannels as part of the subchannel selective transmission.

11. The method of claim 10, wherein the one or more response frames include one or more acknowledgement (ACK) frames, and wherein the selected one or more subchannels are subchannels in which the one or more ACK frames were received.

12. The method of claim 10, wherein the one or more response frames include one or more negative acknowledgement (NACK) frames, and wherein the selected one or more subchannels exclude subchannels in which the one or more NACK frames were received.

13. The method of claim 10, wherein the one or more response frames are received as part of a response A-PPDU transmitted by the STA.

14. The method of claim 13, wherein the A-PPDU and the response A-PPDU use a same subchannel partitioning.

15. A method performed by a station (STA) implemented by a wireless device, comprising:
wirelessly receiving an aggregated physical layer protocol data unit (A-PPDU), wherein the A-PPDU includes a plurality of sub-PPDUs each occupying a different one of a plurality of subchannels, wherein all of the plurality of sub-PPDUs are addressed to the STA; and
attempting to separately decode each of the plurality of sub-PPDUs included in the A-PPDU.

16. The method of claim 15, wherein each of the plurality of subchannels has a bandwidth that is a multiple of 20 Megahertz (MHz).

17. The method of claim 15, wherein each sub-PPDU of the plurality of sub-PPDUs includes a signal field that includes information regarding data and padding included in the sub-PPDU.

18. The method of claim 15, wherein all of the plurality of sub-PPDUs have a same PPDU format.

19. The method of claim 18, wherein the same PPDU format is an ultra high reliability (UHR) PPDU format.

20. The method of claim 15, wherein at least two of the plurality of sub-PPDUs have different PPDU formats.

21. The method of claim 15, wherein one or more of the plurality of sub-PPDUs include a same data and padding.

22. The method of claim 15, wherein all of the plurality of sub-PPDUs include different data and padding.

23. The method of claim 15, further comprising:
wirelessly transmitting one or more response frames in one or more of the plurality of subchannels based on whether the attempts to separately decode the plurality of sub-PPDUs were successful, wherein the one or more response frames are to be used by a transmitter of the A-PPDU to select subchannels for use in a subchannel selective transmission; and
wirelessly receiving a data frame as part of the subchannel selective transmission.

24. The method of claim 23, wherein the one or more response frames include one or more acknowledgement (ACK) frames that occupy one or more subchannels of the plurality of subchannels in which the attempt to decode a sub-PPDU of the A-PPDU was successful.

25. The method of claim 23, wherein the one or more response frames include one or more negative acknowledgement (NACK) frames that occupy one or more of the plurality of subchannels in which the attempt to decode a sub-PPDU of the A-PPDU was unsuccessful.

26. The method of claim 23, wherein the one or more response frames are transmitted in a response A-PPDU.

27. The method of claim 25, wherein the A-PPDU and the response A-PPDU use a same subchannel partitioning.
